(19) United States
(12) Patent Application Publication
(10) Pub. No.: US 2025/0145133 A1
(43) Pub. Date: May 8, 2025

(54) BRAKE SYSTEM FOR AUTOMOBILE

(71) Applicant: HL MANDO CORPORATION, Gyeonggi-do (KR)

(72) Inventors: Hyundong KIM, Gyeonggi-do (KR); Sooyong JEON, Gyeonggi-do (KR); Yeonseong KIM, Gyeonggi-do (KR); Heejun KIM, Gyeonggi-do (KR)

(21) Appl. No.: 18/780,441

(22) Filed: Jul. 22, 2024

(30) Foreign Application Priority Data
Nov. 7, 2023 (KR) 10-2023-0153134

(51) Int. Cl. B60T 13/58; B60T 8/175; B60T 8/176; B60T 8/40; B60T 13/14; B60T 13/68

(52) U.S. Cl. CPC B60T 13/588; B60T 8/175; B60T 8/176; B60T 8/409; B60T 13/142; B60T 13/148; B60T 13/686; B60T 2220/04

(57) ABSTRACT

A brake system for automobile includes: a first brake device provided on two wheels of the automobile, respectively, to perform a braking operation by either transmitted hydraulic pressure or a first electro-mechanical actuator built thereinto; a second brake device provided on other two wheels of the automobile, respectively, to perform the braking operation by a second electro-mechanical actuator built thereinto; a reservoir in which a pressurized medium is stored; a master cylinder device connected to the reservoir and generating the hydraulic pressure corresponding to a displacement of a brake pedal; a hydraulic circuit controlling the hydraulic pressure transmitted from the master cylinder device to the first brake device; and an electronic control unit controlling the first electro-mechanical actuator, the second electro-mechanical actuator and the hydraulic circuit, respectively, so that the first brake device and the second brake device generate braking force in response to the displacement of the brake pedal.

### CROSS-REFERENCE TO RELATED APPLICATIONS

This application claims the benefit of and priority to Korean Patent Application No. 10-2023-0153134 filed on Nov. 7, 2023 in the Korean Intellectual Property Office, the disclosure of which is incorporated herein by reference in its entirety.

### BACKGROUND

### Field

The present disclosure relates to a brake system for automobile, and more particularly, to a brake system for automobile capable of implementing ABS/ESC performance and enabling braking even in failure situations by combining a hydraulic brake device and an electro-mechanical brake device.

### Description of the Related Art

Automobile is essentially equipped with a brake system to perform braking, and various types of brake systems are being proposed to secure safety of a driver and passengers.

The conventional brake system has mainly used a method of supplying hydraulic pressure necessary for braking to a wheel cylinder using a mechanically connected booster when a driver steps on a brake pedal. However, today, as a next generation braking system, an electro-mechanical brake (EMB) system that receives a driver's braking intention as an electrical signal and operates a power transmission device, such as a motor, based on the received electrical signal to provide braking force to the automobile is being developed.

The electro-mechanical brake system converts rotational force of a motor into linear motion through a motor, a reducer, and the like and provides clamping force for a brake disc, thereby performing a service brake and parking brake of the automobile.

However, since the electro-mechanical brake system operates by power, it is difficult to respond to situations such as single fault failure where power is not supplied due to a problem with a power supply of automobile, and since a response speed of an actuator that drives the electro-mechanical brake system is slower than that of the hydraulic brake system, it is difficult to control an anti-lock brake system (ABS), an electronic stability control (ESC), etc.

### SUMMARY

An object to be achieved by the present disclosure is to provide a brake system for automobile capable of implementing ABS/ESC performance and enabling braking even in failure situations by combining a hydraulic brake device and an electro-mechanical brake device.

According to an aspect of the present disclosure, a brake system for automobile may include: a first brake device provided on two wheels of the automobile, respectively, to perform a braking operation by either transmitted hydraulic pressure or a first electro-mechanical actuator built thereinto; a second brake device provided on other two wheels of the automobile, respectively, to perform the braking operation by a second electro-mechanical actuator built thereinto; a reservoir in which a pressurized medium is stored; a master cylinder device connected to the reservoir and generating the hydraulic pressure corresponding to a displacement of the brake pedal; a hydraulic circuit controlling the hydraulic pressure transmitted from the master cylinder device to the first brake device; and an electronic control unit controlling the first electro-mechanical actuator, the second electro-mechanical actuator and the hydraulic circuit, respectively, so that the first brake device and the second brake device generate braking force in response to the displacement of the brake pedal.

The first brake device may be provided on two front wheels of the automobile, respectively, and the second brake device may be provided on two rear wheels of the automobile, respectively.

The first brake device may be provided on two rear wheels of the automobile, respectively, and the second brake device may be provided on two front wheels of the automobile, respectively.

The master cylinder device may include: a cylinder including an internal space having one side connected to the reservoir and the other side connected to the hydraulic circuit and in which the pressurized medium is stored; a piston provided so that at least a portion of the piston advances and retreats inside the cylinder by the brake pedal to discharge the pressurized medium stored in the internal space of the cylinder to the hydraulic circuit; and a feeling damper provided to be compressible as the piston advances and retreats.

The master cylinder device may further include a return spring that provides restoring force according to the advance and retreat of the piston.

The cylinder may further include a simulator port that discharges the pressurized medium stored in the internal space to the reservoir by the advance and retreat of the piston.

The master cylinder device may further include a simulator valve that is provided in a simulator passage connecting the simulator port and the reservoir.

The electronic control unit may switch the simulator valve to an open state while driving the first electro-mechanical actuator.

The simulator valve may be provided as a normal closed-type solenoid valve.

The electronic control unit may switch the simulator valve to a closed state while driving the first brake device by the hydraulic pressure.

The hydraulic circuit may include a plurality of valves disposed in a passage connecting the master cylinder device and the first brake device, and the electronic control unit may control the plurality of valves so that the pressurized medium discharged from the master cylinder device is transmitted to the first brake device based on the displacement of the brake pedal to generate the braking force.

The plurality of valves may include a plurality of normal open-type solenoid valves and normal closed-type solenoid valves provided on upstream and downstream sides of the first brake device, respectively, to control a flow of the hydraulic pressure.

The hydraulic circuit may further include: a low-pressure accumulator temporarily storing the pressurized medium discharged from the first brake device when controlling an anti-lock brake mode; a pump pressing the pressurized medium stored in the low-pressure accumulator to discharge the pressurized medium to the first brake device connected through a hydraulic passage or the master cylinder device connected through a main passage; and a pump motor driving the pump.

The hydraulic circuit may further include: a shuttle valve provided on an auxiliary passage connected from the master cylinder device to an inlet side of the pump for a traction control mode; and a traction control valve provided on a main passage connected between an outlet side of the pump and the master cylinder device.

The shuttle valve may be provided as a normal closed-type solenoid valve.

The traction control valve may be provided as a normal open-type solenoid valve.

The electronic control unit may control the shuttle valve, the traction control valve, and the pump motor to perform control of the anti-lock brake mode or traction control mode.

The electronic control unit may switch the traction control valve to an open state while driving the first electro-mechanical actuator.

According to another aspect of the present disclosure, a brake system for automobile may include: a first brake device provided on two wheels of the automobile, respectively, to perform a braking operation by a transmitted hydraulic pressure; a second brake device provided on other two wheels of the automobile, respectively, to perform the braking operation by an electro-mechanical actuator built thereinto; a reservoir in which a pressurized medium is stored; a master cylinder device connected to the reservoir and generating the hydraulic pressure corresponding to a displacement of the brake pedal; a hydraulic circuit controlling the hydraulic pressure transmitted from the master cylinder device to the first brake device; and an electronic control unit controlling the electro-mechanical actuator and the hydraulic circuit, respectively, so that the first brake device and the second brake device generate braking force in response to the displacement of the brake pedal.

The master cylinder device may include: a cylinder including an internal space having one side connected to the reservoir and the other side connected to the hydraulic circuit and in which the pressurized medium is stored; a piston provided so that at least a portion of the piston advances and retreats inside the cylinder by the brake pedal to discharge the pressurized medium stored in the internal space of the cylinder to the hydraulic circuit; and a feeling damper provided to be compressible as the piston advances and retreats.

According to the brake system of the exemplary embodiment of the present disclosure, some wheels may perform the braking by the hydraulic circuit to ensure the fast response speed, thereby improving ABS, TCS, and ESC control performance.

According to the brake system of the exemplary embodiment of the present disclosure, some wheels may be directly connected to the master cylinder through the hydraulic circuit, thereby generating the braking force even in the failure situation of the brake system.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a hydraulic circuit diagram illustrating a brake system according to an exemplary embodiment of the present disclosure;

FIG. 2 is an enlarged view illustrating a master cylinder device according to an exemplary embodiment of the present disclosure;

FIG. 3 is a hydraulic circuit diagram illustrating a state in which the brake system according to the exemplary embodiment of the present disclosure performs braking by an electro-mechanical actuator;

FIG. 4 is a hydraulic circuit diagram illustrating the state in which the brake system according to the exemplary embodiment of the present disclosure performs the braking by the hydraulic circuit and the electro-mechanical actuator; and

FIG. 5 is a hydraulic circuit diagram illustrating a state in which the brake system according to the exemplary embodiment of the present disclosure performs a fallback mode in which the brake system does not operate normally.

### DETAILED DESCRIPTION OF THE EMBODIMENT

Like reference numerals refer to like components throughout the specification. This specification does not describe all components of the exemplary embodiments, and general content or overlapping content between the exemplary embodiments in the technical field to which the present disclosure pertains is omitted. The term ‘part, module, member, block’ used in the specification may be implemented as software or hardware, and depending on the exemplary embodiment, a plurality of ‘parts, modules, members, or blocks’ may be implemented as a single component, or it is also possible for one ‘part, module, member, or block’ to include multiple components.

Throughout the specification, when a part is said to be “connected” to another part, this includes not only direct connection but also indirect connection, and indirect connection includes connection through a wireless communication network.

In addition, when a part “includes or comprises” a certain component, this means that it may further include other components rather than excluding other components, unless specifically stated to the contrary.

Terms such as first and second are used to distinguish one component from another component, and the components are not limited by the above-mentioned terms.

Singular expressions include plural expressions unless the context clearly makes an exception.

The identification code for each step is used for convenience of explanation. The identification code does not explain the order of each step, and each step may be performed differently from the specified order unless a specific order is clearly stated in the context.

Hereinafter, the operating principle and exemplary embodiments of the present disclosure will be described with reference to the accompanying drawings.

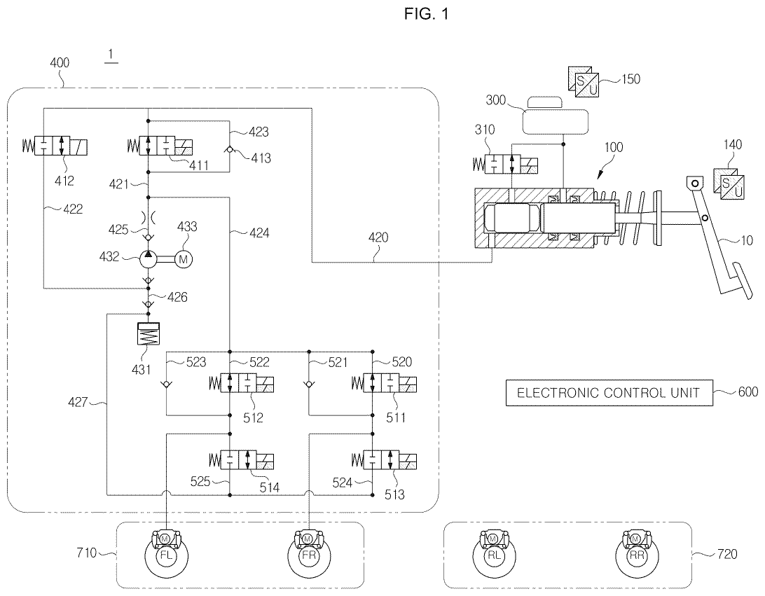

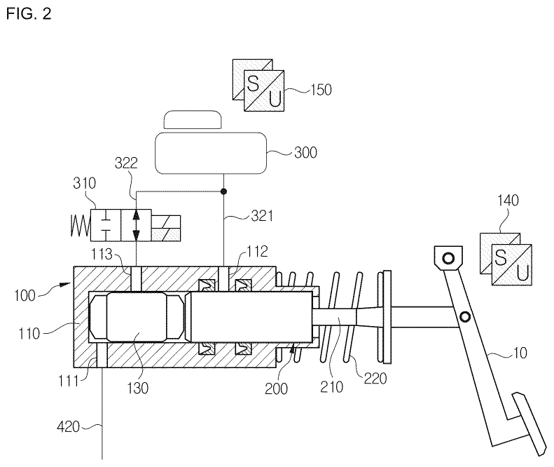

FIG. 1 is a hydraulic circuit diagram illustrating a brake system according to an exemplary embodiment of the present disclosure, and FIG. 2 is an enlarged view illustrating a master cylinder device according to an exemplary embodiment of the present disclosure.

Referring to FIG. 1, a brake system 1 includes a reservoir 300 in which a pressurized medium is stored, a master cylinder device 100 that is connected to the reservoir 300 and generates hydraulic pressure corresponding to a displacement of the brake pedal 10, a first brake device 710 that is supplied with the hydraulic pressure to perform a braking operation of two wheels, a second brake device 720 that performs a braking operation of other two wheels by an electro-mechanical actuator M built thereinto, and a hydraulic circuit 400 that controls the hydraulic pressure transmitted from the master cylinder device 100 to the first brake device.

The first brake device 710 may perform the braking operation by the hydraulic pressure. For example, the first brake device 710 is a disk brake device and may perform the braking operation by pressing a brake pad to a brake disk using the hydraulic pressure transmitted to a wheel cylinder.

Meanwhile, in the exemplary embodiment of the present disclosure, the first brake device 710 may perform the braking operation by either the transmitted hydraulic pressure or the first electro-mechanical actuator M built thereinto. For example, the first brake device 710 may be a disc brake in which the braking is performed by the transmitted hydraulic pressure by a motor-spindle device provided inside the wheel cylinder to which the hydraulic pressure is supplied or by the advance of the spindle device according to the driving of the motor.

Alternatively, in another exemplary embodiment, the first brake device 710 may be an electric drum brake. The electric drum brake may perform the braking operation by pressing brake shoes against the brake drum using the hydraulic pressure supplied to the wheel cylinder provided therein or may perform the braking operation by pressing the brake shoes using the motor-spindle device.

The second brake device 720 may perform the braking operation using the second electro-mechanical actuator M built thereinto. For example, the second brake device 720 may be, as an electro-mechanical brake (EMB), a disc brake which is provided with the motor-spindle device to perform the braking by the advance of the spindle device as the motor is driven.

Alternatively, in another exemplary embodiment, the second brake device 720 may be the electric drum brake. The electric drum brake may perform the braking operation by pressing the brake shoe using the motor-spindle device provided therein.

As illustrated in FIG. 1, the first brake device 710 may be provided on two front wheels FL and FR of automobile, respectively, and the second brake device 720 may be provided on two rear wheels RL and RR of automobile, respectively.

However, the disclosed exemplary embodiment is not limited thereto, and in another exemplary embodiment, the first brake device 710 may be provided on two rear wheels RL and RR of the automobile, respectively, and the second brake device 720 may be provided on two front wheels FL and FR of the automobile, respectively. In the brake system 1 according to the exemplary embodiment of the present disclosure, the first brake device 710 capable of braking by the supplied hydraulic pressure is provided on two wheels, and the second brake device 720 capable of braking by the electro-mechanical actuator is provided on other two wheels, so it is possible to increase the braking performance and implement the braking of the automobile even when the device fails.

The brake system 1 according to the exemplary embodiment of the present disclosure may include an electronic control unit (ECU) 600 that controls the first and second electro-mechanical actuators M and the hydraulic circuit 400, respectively, so that the first brake device 710 and the second brake device 720 generate braking force in response to a displacement of the brake pedal 10.

Referring to FIG. 2, the master cylinder device 100 may include a cylinder 110 including an internal space that has one side connected to the reservoir 300, the other side connected to the hydraulic circuit 400, and in which the pressurized medium is stored, a piston that is provided so that at least a portion of the piston advances and retreats inside the cylinder 110 by the brake pedal 10 to discharge the pressurized medium stored in the internal space of the cylinder 110 to the hydraulic circuit 400, and a feeling damper 130 that is provided to be compressible as the piston 200 advances and retreats.

As described above, the cylinder 110 may include the internal space in which the pressurized medium is stored and the piston 200 advances and retreats and may be provided in a hollow cylindrical shape as a whole.

The cylinder 110 may have an opening formed on one side for insertion of the piston 200, and an inlet port 112 provided on one side.

The inlet port 112 is a passage through which the pressurized medium, such as brake oil, flows in from the reservoir 300 connected through a reservoir passage 321, and may have sealing members provided on both sides of the inlet port 112 to prevent the pressurized medium inside the cylinder 110 from flowing into the reservoir 300. In addition, the inlet port 112 may be provided to be open at an initial position of the piston 200 and closed when the piston 200 advances (moving to the left in FIG. 2).

A discharge port 111 may be provided on the other side of the cylinder 110 so that the pressurized medium stored in the cylinder 110 may be discharged toward the hydraulic circuit 400 as the piston 200 advances.

The discharge port 111 may be provided outside a sliding movement path of the piston 200 and adjacent to the other end side of the cylinder 110 where the feeling damper 130 is inserted. Accordingly, the amount of pressurized medium that is stored in the cylinder 110 discharged through the discharge port 111 may be determined according to the pressure generated by the advance of the piston 200.

The feeling damper 130 may be made of an elastic material such as rubber so that it may be compressed by contact and pressure of the piston 200 to generate a braking sensation provided to a driver. The feeling damper 130 may further include a structure such as a housing for fixation to the cylinder 110.

The piston 200 is connected to a push rod 210 and is coupled to the cylinder 110 so that it can advance and retreat in an axial direction of the cylinder 110.

One end of the push rod 210 is directly or indirectly connected to the brake pedal 10, and the other end thereof is connected to the piston 200. Accordingly, the piston 200 may advance by the push rod 210 when a driver steps on the brake pedal.

The master cylinder device 100 may further include a return spring 220 that provides restoring force according to the advance and retreat of the piston 200. The return spring 220 may be formed of various types of elastic force providing means, including a coil spring. Accordingly, in an initial state, the piston 200 is provided to be spaced apart from the cylinder 110 in the axial direction by the return spring 220. In addition, when the driver steps on the brake pedal, the piston 200 advances toward the cylinder 110 by the push rod 210, and the return spring 220 is compressed accordingly, so a pedal feeling may be provided to the driver.

In the master cylinder device of the present disclosure, in the initial state, the pressurized medium stored in the reservoir 300 flows into the internal space of the cylinder 110 through the inlet port 112, and in the operating state, as the piston 200 advances, the pressurized medium is discharged to the discharge port 111 by the pressure, so even if a partial failure of the brake system 1 occurs without the need to add a separate structure or configuration, a passive fail safe function that may perform the braking by manipulating the brake pedal 10 of the driver may be provided.

Meanwhile, in the exemplary embodiment of the present disclosure, the cylinder 110 may further include a simulator port 113 that discharges the pressurized medium stored in the internal space to the reservoir 300 by the advance and retreat of the piston 200.

Similar to the discharge port 111, the simulator port 113 may be provided outside a sliding movement path of the piston 200 and adjacent to the other end side of the cylinder 110 into which the feeling damper 130 is inserted. Accordingly, as the piston 200 advances, the pressurized medium may be discharged to the simulator port 113 by the pressure.

As the master cylinder device 100 including the above-described configuration may be used as the master cylinder while providing the pedal feeling to the driver in the brake system 1, it is possible to simplify the structure of the conventional electronic brake system that separately includes the pedal simulator and the master cylinder.

In addition, when the master cylinder device 100 is applied to various electronic brake systems, including an electronic caliper brake system and an electro-mechanical brake (EMB) system, the master cylinder device 100 is capable of transmitting the hydraulic pressure to the wheel cylinder side that provides the braking force, thereby providing the passive fail safe function capable of performing the braking by operating the brake pedal by the driver even if a partial failure of the electronic brake system occurs without the need to add the separate structure or configuration.

Meanwhile, in the exemplary embodiment of the present disclosure, the master cylinder device 100 may further include a simulator valve 310 provided in the simulator passage 322 connecting the simulator port 113 and the reservoir 300. The electronic control unit 600 of the brake system 1 controls the opening and closing of the simulator valve 310 during the braking to discharge the pressurized medium of the internal space of the cylinder 110 to the reservoir 300 through the simulator port 113 or discharge the pressurized medium to the hydraulic circuit 400 without flowing out into the reservoir 300 through the discharge port 111.

In the exemplary embodiment of the present disclosure, the simulator valve 310 may be provided as a normal closed-type solenoid valve.

In addition, the brake system 1 according to the exemplary embodiment of the present disclosure may further include a reservoir displacement sensor 150 that detects a water level of the reservoir 300.

Referring back to FIG. 1, the brake system 1 may include the hydraulic circuit 400 that controls the flow of hydraulic pressure transmitted to the first brake device 710 provided on two wheels, and the electronic control unit 600 that controls valves of the hydraulic circuit 400 based on the hydraulic pressure information and the pedal displacement information.

The hydraulic circuit 400 may control the first brake device 710 by being supplied with the hydraulic pressure. The first brake device 710 is installed on two wheels to be supplied with the hydraulic pressure, thereby performing the braking.

The hydraulic circuit 400 may be supplied with the hydraulic pressure from the master cylinder device 100 through the master cylinder passage 420 connected to the discharge port 111 of the master cylinder device 100 and transmit the hydraulic pressure to the wheel cylinder of the first brake device 710, so the first brake device 710 may perform the braking.

The hydraulic circuit 400 may include a plurality of valves disposed in a passage connecting the master cylinder device 100 and the first brake device 710. The plurality of valves is provided on the upstream and downstream sides of the first brake device 710, respectively, and may include a plurality of normal open-type solenoid valves and normal closed-type solenoid valves that control the flow of hydraulic pressure. Specifically, the hydraulic circuit 400 may include a plurality of inlet valves 511 and 512 and outlet valves 513 and 514 to control the flow of hydraulic pressure during the braking and braking release.

In the exemplary embodiment illustrated in FIG. 1, the hydraulic pressure generated in the master cylinder device 100 is transmitted through a master cylinder passage 420, a main passage 421, and a hydraulic passage 424. The hydraulic circuit 400 may include first and second inlet valves 511 and 512 installed that are each provided in the first inlet passage 520 and the second inlet passage 522 branched from the hydraulic passage 424 and control the hydraulic pressure transmitted to the first brake device 710.

In addition, the inlet valves 511 and 512 are disposed on the upstream side of the first brake device 710 and may be provided as the normal open-type solenoid valve that is open at ordinary times and then operates to close the valve when receiving a closing signal from the electronic control unit 600.

The hydraulic circuit 400 may include a first inlet bypass passage 521 and a second inlet bypass passage 523 installed that connect the upstream and downstream sides of the first inlet valve 511 and the second inlet valve 512, respectively. The first inlet bypass passage 521 and the second inlet bypass passage 523 may each be provided with a check valve that blocks the flow of pressurized medium flowing from the master cylinder device 100 to the first brake device 710 while allowing the flow of pressurized medium flowing from the first brake device 710 to the master cylinder device 100.

In addition, the hydraulic circuit 400 may have first and second outlet valves 513 and 514 installed that are each provided in a first outlet passage 524 and a second outlet passage 525 that branch from the return passage 427 and each connect downstream sides of the first and second inlet valves 511 and 512 and a low-pressure accumulator 431 side to be described below to control the hydraulic pressure discharged from the first brake device 710.

In addition, the outlet valves 513 and 514 are disposed on the downstream side of the first brake device 710 and may be provided as the normal closed-type solenoid valve that is closed at ordinary times and then operates to open the valve when receiving an open signal from the electronic control unit 600.

The inlet valves 511 and 512 are provided in the inlet passages 520 and 522 connecting the master cylinder device 100 and the first brake device 710 to control the hydraulic pressure to be provided to the first brake device 710 of two wheels during the braking. That is, the inlet valves 511 and 512 may detect the required braking pressure of the first brake device 710 of each wheel and may be selectively open when the braking is necessary, thereby controlling the pressure.

In addition, the outlet valves 513 and 514 are provided in the outlet passages 524 and 525 connected to the return passage 427 connecting the low-pressure accumulator 431 and the first brake device 710 to control the hydraulic pressure to escape from each wheel when the braking is released. That is, the outlet valves 513 and 514 may detect the braking pressure of each wheel and may be selectively open when decompression braking is necessary, thereby controlling the pressure.

Meanwhile, the hydraulic circuit 400 may include the low-pressure accumulator 431 in which the pressurized medium discharged from the first brake device 710 is temporarily stored when controlling an anti-lock brake mode, a pump 432 that presses the pressurized medium stored in the low-pressure accumulator 431 and discharges the pressurized medium to the first brake device 710 or the master cylinder device 100, and a pump motor 433 that drives the pump 432.

The low-pressure accumulator 431 temporarily stores the pressurized medium discharged from the first brake device 710. To this end, the low-pressure accumulator 431 is connected to the first brake device 710 through the first and second outlet passages 524 and 525 and the return passage 427.

The pump 432 is driven by the pump motor 433 to suction the pressurized medium stored in the master cylinder device 100 connected through the low-pressure accumulator 431 connected through a suction passage 436 or the master cylinder device 100 connected through an auxiliary passage 422 and discharge the sucked pressurized medium to the main passage 421 connected through the discharge passage 425, thereby transmitting the hydraulic pressure to the first brake device 710 or the master cylinder device 100.

Meanwhile, the hydraulic circuit 400 may include a shuttle valve 412 that is provided on the auxiliary passage 422 connected from the master cylinder device 100 to the inlet side of the pump 432 for a traction control mode and a traction control valve 411 that is provided on the main passage 421 connected between the outlet side of the pump 432 and the master cylinder device 100.

The traction control valve 411 is provided as the normal open-type solenoid valve. The traction control valve 411 is maintained in an open state at ordinary times to transmit the braking hydraulic pressure formed in the master cylinder device 100 to the first brake device 710 through the main passage 421 during the normal braking through the brake pedal 10.

The shuttle valve 412 is provided as the normal closed-type solenoid valve. The shuttle valve 412 is closed at ordinary times and is open in the traction control mode to allow the pressurized medium of the master cylinder device 100 to be supplied to the pump 432 through the auxiliary passage 422.

The electronic control unit 600 may control a plurality of valves 411, 412, 511, 512, 513, and 514 provided in the hydraulic circuit 400 so that the pressurized medium discharged from the hydraulic actuator based on the displacement of the brake pedal 10 is transmitted to the first brake device to generate the braking force.

The pedal displacement sensor 140 detects the displacement of the brake pedal 10 to transmit an electrical signal to the electronic control unit 600. The electronic control unit 600 analyzes the signal from the pedal displacement sensor 140 to determine the braking pressure required by the driver, and outputs signals for controlling the pump motor 433 and various valves 411, 412, 511, 512, 513, and 514 to satisfy the braking pressure.

When increasing the hydraulic pressure of the first brake device 710, the electronic control unit 600 opens the inlet valves 511 and 512 and closes the outlet valves 513 and 514 and drives the pump 432 so that the pressurized medium with the increased pressure is supplied to the wheel cylinder of the first brake device 710. As a result, the hydraulic pressure of the wheel cylinder of the first brake device 710 may increase. As the hydraulic pressure within the wheel cylinder increases, the first brake device 710 may generate the braking force.

When maintaining the hydraulic pressure of the first brake device 710, the electronic control unit 600 may close the inlet valves 511 and 512 and the outlet valves 513 and 514, respectively, to maintain the hydraulic pressure of the wheel cylinder of the first brake device 710.

When reducing the hydraulic pressure of the first brake device 710, the electronic control unit 600 stops the pump 432, closes the inlet valves 511 and 512, and opens the outlet valves 513 and 514 to make the pressurized medium of the wheel cylinder of the first brake device 710 return to the low-pressure accumulator 431 along the return passage 427. As a result, it is possible to reduce the hydraulic pressure of the wheel cylinder of the first brake device 710.

The electronic control unit 600 may individually control the driving of various valves and the pump motor 433 of the hydraulic circuit 400 based on the detection information received from the brake pedal displacement sensor 140, the accelerator pedal displacement sensor (not illustrated), and the wheel speed sensor (not illustrated).

In addition, the electronic control unit 600 may individually control the driving of various valves and the pump motor 433 of the hydraulic circuit 400 based on the detection information received from the brake pedal displacement sensor 140, the accelerator pedal displacement sensor (not illustrated), and the wheel speed sensor (not illustrated) and various types of information received from other systems, for example, driver assistance systems.

The electronic control unit 600 may control the shuttle valve 412, the traction control valve 411, and the pump motor 433 to perform control of the anti-lock brake mode or the traction control mode. The electronic control unit 600 may receive control signals from devices such as the driver assistance systems provided in the automobile to perform control of the anti-lock brake mode or the traction control mode.

The electronic control unit 600 may include a processor and a memory.

The memory may store programs for processing or control of the processor and various data for operation of the brake system. The memory 34b may include not only volatile memories such as S-RAM and D-RAM, but also non-volatile memory such as flash memory, read only memory (ROM), and erasable programmable read only memory (EPROM).

The processor may control the overall operation of the brake system 1.

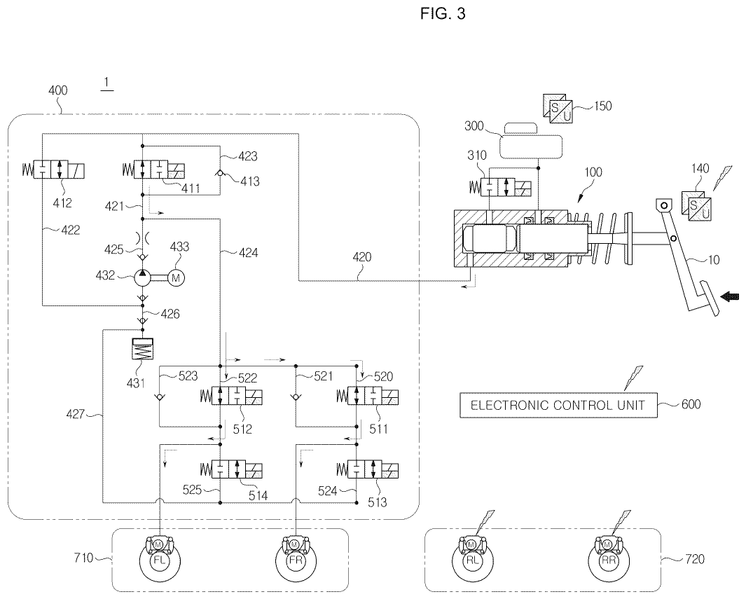

FIG. 3 is a hydraulic circuit diagram illustrating a state in which the brake system according to the exemplary embodiment of the present disclosure performs the braking by the electro-mechanical actuator.

The brake system 1 according to the exemplary embodiment of the present disclosure may perform the braking by the electro-mechanical actuator provided in the first brake device 710 and the second brake device 720.

When the brake system 1 performs the braking by both the first brake device 710 and the second brake device 720 using the electro-mechanical actuator M, the electronic control unit 600 drives the electro-mechanical actuator M according to the electrical signal of the pedal displacement sensor 140, that is, the electrical signal output in response to the displacement of the brake pedal 10. More specifically, the electronic control unit 600 derives a target braking pressure according to the electrical signal from the pedal displacement sensor 140 and drives the electro-mechanical actuators M of the first brake device 710 and the second brake device 720 based on the derived target braking pressure to press a friction material to a rotor, thereby generating the braking force.

The electronic control unit 600 switches the simulator valve 310 and the traction control valve 411 to the open state while driving the first electro-mechanical actuator M of the first brake device 710 to make the wheel cylinder of the first brake device 710 communicate with the reservoir 300. Therefore, it is possible to prevent the pressure inside the master cylinder device 100 from increasing due to the flow of pressurized medium inside the wheel cylinder of the first brake device 710 and to prevent kickback which applies shock to the brake pedal 10.

In this case, a driver may receive appropriate reaction force according to pedal force of the brake pedal 10 by the return spring 220 and the feeling damper 130 provided in the master cylinder device 100.

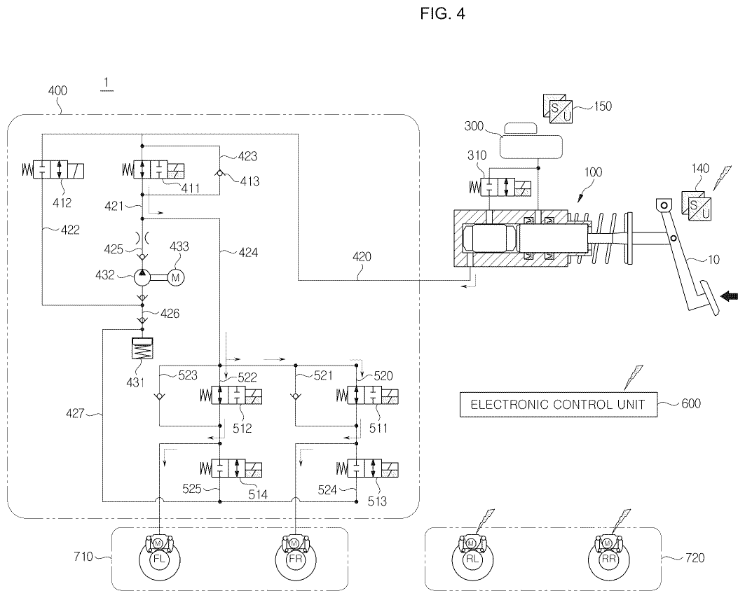

FIG. 4 is a hydraulic circuit diagram illustrating the state in which the brake system according to the exemplary embodiment of the present disclosure performs the braking by the hydraulic circuit and the electro-mechanical actuator.

Meanwhile, the brake system 1 according to the exemplary embodiment of the present disclosure may simultaneously perform the braking by the hydraulic pressure generated from the master cylinder device 100 and the braking by the driving of the electro-mechanical actuator M.

When the brake system 1 performs the braking by the first brake device 710 using the hydraulic circuit 400 and the second brake device 720 using the electro-mechanical actuator M, the electronic control unit 600 drives the hydraulic circuit 400 and the electro-mechanical actuator M, respectively, according to the electrical signal of the pedal displacement sensor 140, that is, the electrical signal output in response to the displacement of the brake pedal 10. More specifically, the electronic control unit 600 derives the target braking pressure according to the electrical signal from the pedal displacement sensor 140, and controls the driving of the pump motor 433 and the opening and closing of the plurality of valves 411, 412, 511, 512, 513, and 514, which are provided in the hydraulic circuit 400, to transmit the hydraulic pressure to the first brake device 710 based on the derived target braking pressure, thereby pressing the friction material of the first brake device 710 to the rotor, and at the same time, drives the second electro-mechanical actuator M of the second brake device 720 to press the friction material to the rotor, thereby generating the braking force.

In an exemplary embodiment of the present disclosure, the electronic control unit 600 may supply the hydraulic pressure to the first brake device 710 through the hydraulic circuit 400, and at the same time, drive the first electro-mechanical actuator M to press the friction material of the first brake device 710 to the rotor. To this end, the electronic control unit 600 derives the target braking force through the hydraulic circuit 400 and the target braking force by the first electro-mechanical actuator M, respectively, to derive the final target braking force of the first brake device 710, thereby controlling the braking.

Meanwhile, the electronic control unit 600 switches the simulator valve 310 to the closed state while driving the first brake device 710 by the hydraulic pressure to transmit the hydraulic pressure inside the master cylinder device 100 generated by the pedal force of the brake pedal 10 to the hydraulic circuit 400 through the master cylinder passage 420.

The brake system 1 according to the exemplary embodiment of the present disclosure may effectively discharge only the braking pressure provided to each wheel cylinder of the first brake device 710 through the first and second outlet valves 513 and 514.

For example, when the first and second inlet valves 511 and 512 are switched to the closed state, the first outlet valve 513 is maintained in the closed state, and the second outlet valve 514 is switched to the open state, the hydraulic pressure discharged from the first brake device 710 installed on the left front wheel FL is discharged to the low-pressure accumulator 431 through the second outlet valve 514.

The reason why the hydraulic pressure of the first brake device 710 is discharged through the outlet valves 513 and 514 is because the pressure in the low-pressure accumulator 431 is less than the pressure in the wheel cylinder of the first brake device 710. When the low-pressure accumulator 431 is maintained at low pressure and the pressurized medium flows in and the pressure increases, the stored pressurized medium may be discharged by the pump 432. Since the pressure within the wheel cylinder is usually significantly higher than atmospheric pressure, when the outlet valves 513 and 514 are open, the hydraulic pressure of the wheel cylinder is quickly discharged to the low-pressure accumulator 431.

On the other hand, when the second outlet valve 514 is open to discharge the hydraulic pressure of the wheel cylinder of the first brake device 710, and at the same time, the first inlet valve 511 is switched to the open state, the hydraulic pressure may be supplied to the right front wheel FR.

In this way, the electronic control unit 600 independently controls each valve 511, 512, 513, or 514 of the hydraulic circuit 400 to selectively transmit or discharge the hydraulic pressure to the wheel cylinder of each wheel FL and FR provided with the first brake device 710 according to the required pressure, thereby enabling the precise pressure control.

In this way, by simultaneously performing the braking by the hydraulic circuit and the electro-mechanical actuator, the brake system 1 may determine the driver's intention to brake according to the displacement of the brake pedal 10 and control the first brake device 710 and the second brake device 720 to generate the braking force according to the displacement of the brake pedal 10.

In addition, compared to performing the braking using only the electro-mechanical actuator M, the brake system 1 may use the hydraulic circuit 400 to perform the functions, such as the anti-lock brake mode control, the traction control mode control, and the electronic stability control mode control, through the fast and precise pressure control.

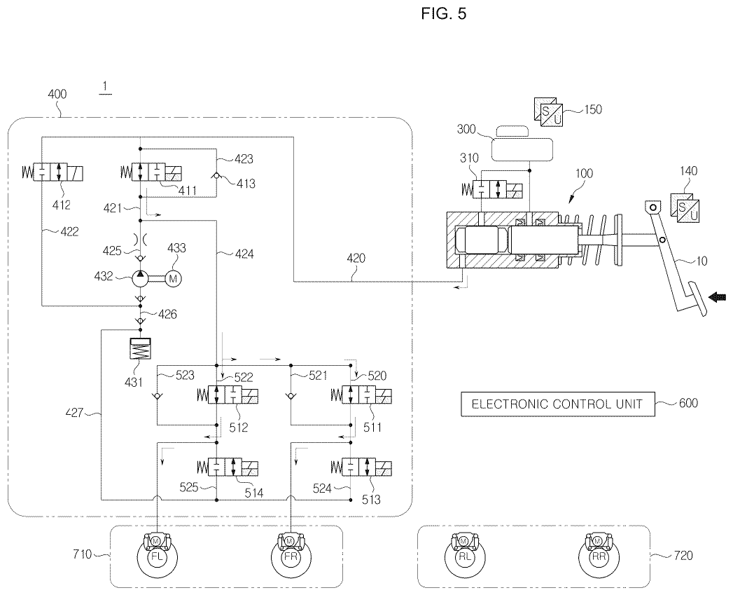

FIG. 5 is a hydraulic circuit diagram illustrating the state in which the brake system according to the exemplary embodiment of the present disclosure performs a fallback mode in which the brake system does not operate normally.

When the brake system 1 does not operate normally, each valve 411, 412, 511, 512, 513, or 514 is provided to an initial braking state which is in a non-operating state.

When the driver presses the brake pedal 10, the piston 200 connected to the brake pedal 10 advances, and the hydraulic pressure discharged from the cylinder 110 by pressing or moving the piston 200 is directly transmitted to the first brake device 710 through the connected master cylinder passage 420, the main passage 421, the hydraulic passage 424, and the first and second inlet passages 520 and 522 to implement the braking force.

In this case, the simulator valve 310 provided in the simulator passage 322 connecting the internal space of the cylinder 110 and the reservoir 300 is composed as the normal closed-type solenoid valve and the hydraulic pressure discharged from the cylinder 110 is prevented from leaking to the reservoir 300.

In addition, as the traction control valve 411 provided in the main passage 421 and the inlet valves 511 and 512 provided in the inlet passages 520 and 522 are composed as the normal open-type solenoid valve, and the outlet valves 513 and 514 provided in the outlet passages 524 and 525 are composed as the normal closed-type solenoid valve, the discharged hydraulic pressure is directly transmitted to the first brake device 710. As a result, it is possible to perform the stable braking and improve the braking stability.

As described above, the disclosed exemplary embodiments have been described with reference to the attached drawings. A person skilled in the art to which the present disclosure pertains will understand that the present disclosure can be practiced in forms different from the disclosed exemplary embodiments without changing the technical idea or essential features of the present disclosure. The disclosed exemplary embodiments are illustrative and should not be construed as limiting.

What is claimed is:

1. A brake system for automobile, comprising:
a first brake device provided on two wheels of the automobile, respectively, to perform a braking operation by either transmitted hydraulic pressure or a first electro-mechanical actuator built thereinto;
a second brake device provided on other two wheels of the automobile, respectively, to perform the braking operation by a second electro-mechanical actuator built thereinto;
a reservoir in which a pressurized medium is stored;
a master cylinder device connected to the reservoir and generating the hydraulic pressure corresponding to a displacement of a brake pedal;
a hydraulic circuit controlling the hydraulic pressure transmitted from the master cylinder device to the first brake device; and
an electronic control unit controlling the first electro-mechanical actuator, the second electro-mechanical actuator and the hydraulic circuit, respectively, so that the first brake device and the second brake device generate braking force in response to the displacement of the brake pedal.

2. The brake system for automobile of claim 1, wherein the first brake device is provided on two front wheels of the automobile, respectively, and
the second brake device is provided on two rear wheels of the automobile, respectively.

3. The brake system for automobile of claim 1, wherein the first brake device is provided on two rear wheels of the automobile, respectively, and
the second brake device is provided on two front wheels of the automobile, respectively.

4. The brake system for automobile of claim 1, wherein the master cylinder device includes:
a cylinder including an internal space having one side connected to the reservoir and the other side connected to the hydraulic circuit and in which the pressurized medium is stored;
a piston provided so that at least a portion of the piston advances and retreats inside the cylinder by the brake pedal to discharge the pressurized medium stored in the internal space of the cylinder to the hydraulic circuit; and
a feeling damper provided to be compressible as the piston advances and retreats.

5. The brake system for automobile of claim 4, wherein the master cylinder device further includes a return spring that provides restoring force according to the advance and retreat of the piston.

6. The brake system for automobile of claim 5, wherein the cylinder further includes a simulator port that discharges the pressurized medium stored in the internal space to the reservoir by the advance and retreat of the piston.

7. The brake system for automobile of claim 6, wherein the master cylinder device further includes a simulator valve that is provided in a simulator passage connecting the simulator port and the reservoir.

8. The brake system for automobile of claim 7, wherein the electronic control unit switches the simulator valve to an open state while driving the first electro-mechanical actuator.

9. The brake system for automobile of claim 8, wherein the simulator valve is provided as a normal closed-type solenoid valve.

10. The brake system for automobile of claim 7, wherein the electronic control unit switches the simulator valve to a closed state while driving the first brake device by the hydraulic pressure.

11. The brake system for automobile of claim 1, wherein the hydraulic circuit includes a plurality of valves disposed in a passage connecting the master cylinder device and the first brake device, and
the electronic control unit controls the plurality of valves so that the pressurized medium discharged from the master cylinder device is transmitted to the first brake device based on the displacement of the brake pedal to generate the braking force.

12. The brake system for automobile of claim 11, wherein the plurality of valves includes a plurality of normal open-type solenoid valves and normal closed-type solenoid valves provided on upstream and downstream sides of the first brake device, respectively, to control a flow of the hydraulic pressure.

13. The brake system for automobile of claim 11, wherein the hydraulic circuit includes:
a low-pressure accumulator temporarily storing the pressurized medium discharged from the first brake device when controlling an anti-lock brake mode;
a pump pressing the pressurized medium stored in the low-pressure accumulator and discharging the pressurized medium to the first brake device connected through a hydraulic passage or the master cylinder device connected through a main passage; and
a pump motor that drives the pump.

14. The brake system for automobile of claim 13, wherein the hydraulic circuit further includes:
a shuttle valve provided on an auxiliary passage connected from the master cylinder device to an inlet side of the pump for a traction control mode; and
a traction control valve provided on a main passage connected between an outlet side of the pump and the master cylinder device.

15. The brake system for automobile of claim 14, wherein the shuttle valve is provided as a normal closed-type solenoid valve.

16. The brake system for automobile of claim 14, wherein the traction control valve is provided as a normal open-type solenoid valve.

17. The brake system for automobile of claim 14, wherein the electronic control unit controls the shuttle valve, the traction control valve, and the pump motor to perform control of the anti-lock brake mode or the traction control mode.

18. The brake system for automobile of claim 14, wherein the electronic control unit switches the traction control valve to an open state while driving the first electro-mechanical actuator.

19. A brake system for automobile, comprising:
a first brake device provided on two wheels of the automobile, respectively, to perform a braking operation by transmitted hydraulic pressure;
a second brake device provided on other two wheels of the automobile, respectively, to perform the braking operation by an electro-mechanical actuator built thereinto;
a reservoir in which a pressurized medium is stored;
a master cylinder device connected to the reservoir and generating the hydraulic pressure corresponding to a displacement of a brake pedal;
a hydraulic circuit controlling the hydraulic pressure transmitted from the master cylinder device to the first brake device; and
an electronic control unit controlling the electro-mechanical actuator and the hydraulic circuit, respectively, so that the first brake device and the second brake device generate braking force in response to the displacement of the brake pedal.

20. The brake system for automobile of claim 19, wherein the master cylinder device includes:
a cylinder including an internal space having one side connected to the reservoir and the other side connected to the hydraulic circuit and in which the pressurized medium is stored;
a piston provided so that at least a portion of the piston advances and retreats inside the cylinder by the brake pedal to discharge the pressurized medium stored in the internal space of the cylinder to the hydraulic circuit; and
a feeling damper provided to be compressible as the piston advances and retreats.
